(19) United States
(12) Patent Application Publication
(10) Pub. No.: US 2014/0291467 A1
(43) Pub. Date: Oct. 2, 2014

(54) CARRYING DEVICE

(71) Applicant: ULIKE CORPORATION, New Taipei City (TW)

(72) Inventor: Jui-Lien YANG, New Taipei City (TW)

(73) Assignee: ULIKE CORPORATION, New Taipei City (TW)

(21) Appl. No.: 14/227,792

(22) Filed: Mar. 27, 2014

(30) Foreign Application Priority Data
Mar. 27, 2013 (TW) 102205685

(51) Int. Cl. F16M 11/18; F16M 11/22

(52) U.S. Cl. CPC F16M 11/18; F16M 11/22
USPC 248/424

(57) ABSTRACT

A carrying device comprises a sliding rail, a support stand and a plurality of rods. The sliding rail comprises a fixed rail and a withdraw rail. The withdraw rail is configured for moving back and forth relative to the fixed rail. The support stand has a top surface. The sleeve holes are disposed on the top surface. The sleeve holes have a sleeved axis, while opposite two ends of the support stand respectively have at least one installation hole having an installation axis. The sleeved axis and the installation axis do not intersect, and the withdraw rail is installed on the installation hole of the support stand. The rods each have a fixed end and a cantilever end opposite to each other. Each of the fixed ends is installed on each of the sleeve holes of the support stand.

### CROSS-REFERENCE TO RELATED APPLICATIONS

This non-provisional application claims priority under 35 U.S.C. §119(a) on Patent Application No(s). 102205685 filed in Taiwan, R.O.C. on 2013 Mar. 27, the entire contents of which are hereby incorporated by reference.

### TECHNICAL FIELD

The disclosure relates to a carrying device, more particularly to a carrying device having a sliding rail and a support stand.

### BACKGROUND

Nowadays a carrying device comprises a pair of sliding rails and a support stand having multiple rods for placing goods. The two ends of the support stand are disposed on the sliding rails while the rods are for hanging pants, skirts, clothes, etc. The rails are plugged into the installation holes of the support stand via the protruding portions while the rods are installed in the sleeve holes. The installation holes on the edge of the support stand is often intersected with and interfered with the sleeve holes so that the edge of the support stand cannot be used for the rods to be installed on. As a result, the number of the rods installed is insufficient and the space of the two ends of the support stand cannot be fully utilized.

### SUMMARY

A carrying device comprises a sliding rail, a support stand and a plurality of rods. The sliding rail comprises a fixed rail and a withdraw rail. The withdraw rail is configured for moving back and forth relative to the fixed rail. The support stand has a top surface. The sleeve holes are disposed on the top surface. The sleeve holes have a sleeved axis, while opposite two ends of the support stand respectively have at least one installation hole having an installation axis. The sleeved axis and the installation axis do not intersect, and the withdraw rail is installed on the installation hole of the support stand. The rods each have a fixed end and a cantilever end opposite to each other. Each of the fixed ends is installed on each of the sleeve holes of the support stand.

### BRIEF DESCRIPTION OF THE DRAWINGS

The present disclosure will become more fully understood from the detailed description and the drawings given herein below for illustration only, and thus does not limit the present disclosure, wherein:

FIG. 1A is a perspective view of a carrying device according to one embodiment of the disclosure;

FIB 1B is an exploded view of FIG. 1A;

FIG. 1C is a partial exploded view of the carrying device according to one embodiment of the disclosure;

FIG. 2 is a partial exploded view of the carrying device according to another embodiment of the disclosure;

FIG. 3 is a partial exploded view of the carrying device according to another embodiment of the disclosure; and

FIG. 4 is a partial exploded view of the carrying device according to another embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

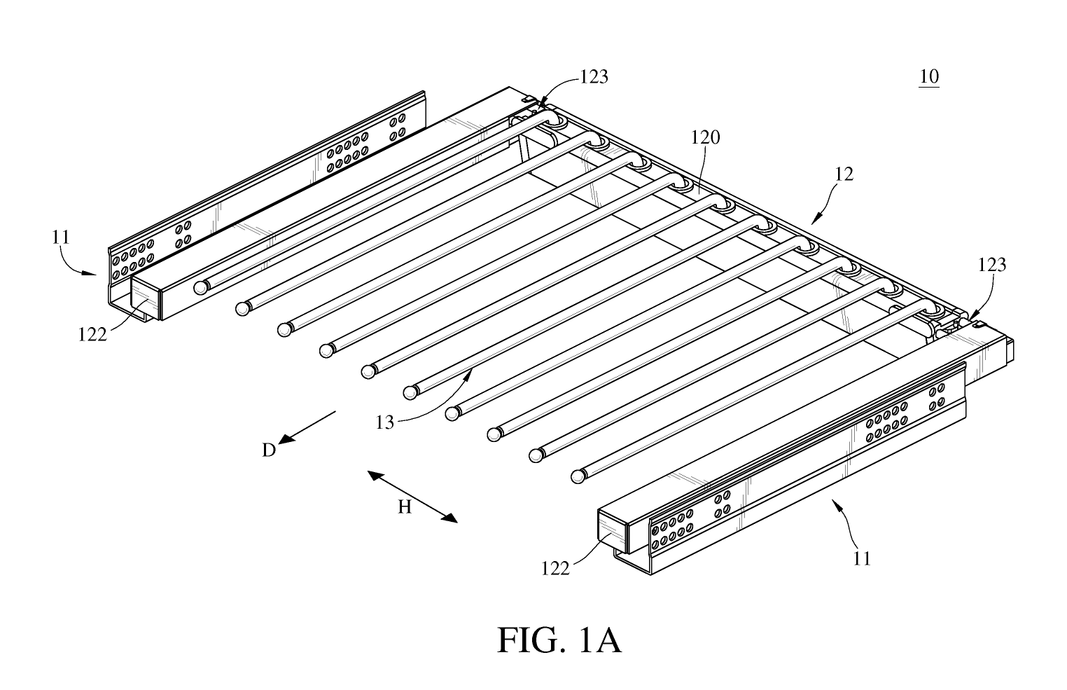

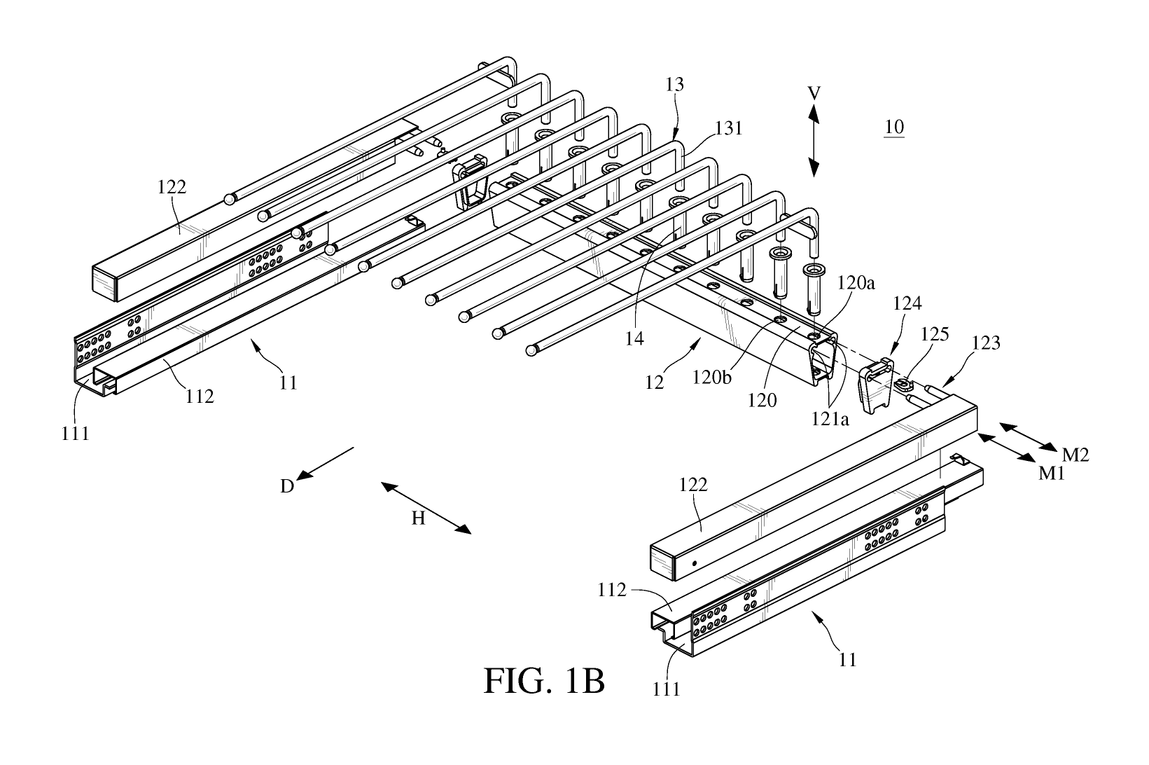

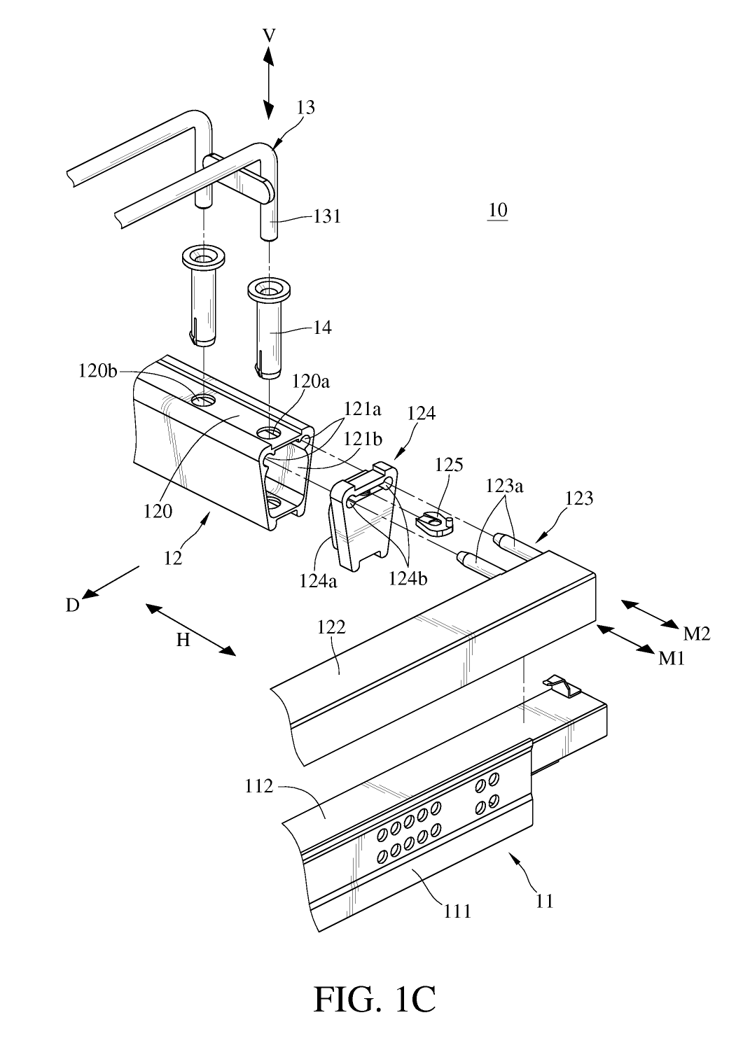

FIG. 1A is a perspective view of a carrying device according to one embodiment of the disclosure; FIB 1B is an exploded view of FIG. 1A; FIG. 1C is a partial exploded view of the carrying device according to one embodiment of the disclosure. As seen in FIG. 1A to FIG. 1C, the carrying device 10 comprises a pair of sliding rails 11, a support stand 12 and a plurality of rods 13. Each sliding rail 11 comprises a fixed rail 111 and a withdraw rail 112. Each withdraw rail 112 is capable of moving back and forth relative to each fixed rail 111. The support plate 12 has a top surface 120 and a plurality of sleeve holes 120a and 120b are disposed on the top surface 120. The sleeve holes 120a and 120b has a sleeved axis V. The opposite two ends of the support stand 12 each have two installation holes 121a.

The two installation holes 121a have two installation axes M1 and M2. The installation holes 121 a are located on the two sides of the sleeved axis V while the sleeved axis V and the installation axes M1 and M2 do not intersect and thus do not interfere with each other. The withdraw rail 112 is installed on the installation hole 121a of the support stand. Each rod 13 has a fixed end 131 and a cantilever end 132 opposite to each other. These fixed ends may be installed in the sleeve holes 120a and 120b of the support stand 12.

Each sliding rail 11 has a withdraw direction D while the withdraw rail 112 may move away from the fixed rail 111 along the withdraw direction D. Each fixed end 131 of each rod 13 is installed in each sleeve hole 120a and 120b by being installed along the withdraw direction D.

The carrying device 10 further comprises a sliding sleeve member 122, a pair of protruding portions 123 and a plurality of sleeves 14. Each fixed end 131 is installed in each sleeved hole 120a and 120b via each sleeve 14. Each protruding portion 123 is fixed to each sliding sleeve member 122. Each sliding sleeve member 122 is disposed on each withdraw rail 112 and sliding sleeve members 122 are located on the opposite two ends of the support stand 12.

Each protruding portion 123 comprises two pluggable member 123a which are installed in each installation hole 121a along the installation axes M1 and M2.

Each support stand 12 further comprises an end cover 124. Each end cover 124 comprises a pluggable protrusion 124a and has two through channels 124b. The two ends of the support stand 12 has two recessed portions 121b which connects the installation hole 121 a. The sleeve hole 120a at the end of the support stand 12 connects the recessed portion 121b. Each pluggable portion 124a is plugged in each recessed portion 121b. The two pluggable members 123a of each protruding portion 123 are respectively plugged in the two through channels 124b of the end cover 124.

Moreover, the carrying device 10 further comprises two fixing members 125 each disposed between the two through channels 124b of each end cover 124. Each fixing member 125 is able to move between a first position and a second position. Each fixing member 125 at the first position may fix each protruding portion 123 and each end cover 124. Furthermore, each protruding portion 123 and each end cover 124 can move along the horizontal direction H relative to each other when the fixing member 125 is at the second position.

In this embodiment, the two pluggable members 123a are arranged along the withdraw direction D and along a protruding direction of the installation hole 121a, but the disclosure is not limited thereto. In other embodiments, the two pluggable members protrude towards the horizontal direction H of the installation hole 121a and are arranged along the horizontal direction H which is perpendicular to the withdraw direction D. The two pluggable members 123a of each protruding portion 123 are locked into each sliding sleeve member 122. The support stand 12 is a hollow component which connects the recessed portion 121b, but it is not limited thereto. In other embodiments, the support stand 12 may be a solid component which does not connect the recessed portion 121b.

In this embodiment, the sliding rails 11 may be installed on two side walls (not shown in the figures). Each fixing member 125 may locate each end cover 124 and each sliding sleeve member 122 to be along the horizontal direction H and with certain distances between them. When each end cover 124 is near each sliding sleeve member 122, the length of protruding portion 123 inside each installation hole 121b is longer. Thereby, the distance between the two sliding sleeve members 122 is reduced to match the two sliding rails 11 with shorter distance. When each end cover 124 is further away from each sliding sleeve member 122, the length of protruding portion 123 inside each installation hole 121b is shorter. Thus, the distance between the two sliding sleeve members 122 may be elongated to match the two sliding rails 11 with longer distance between them. In other words, each end cover may adjust the distance between the two sliding sleeve members 122 so that the carrying device 10 can be installed on two side walls with different distances.

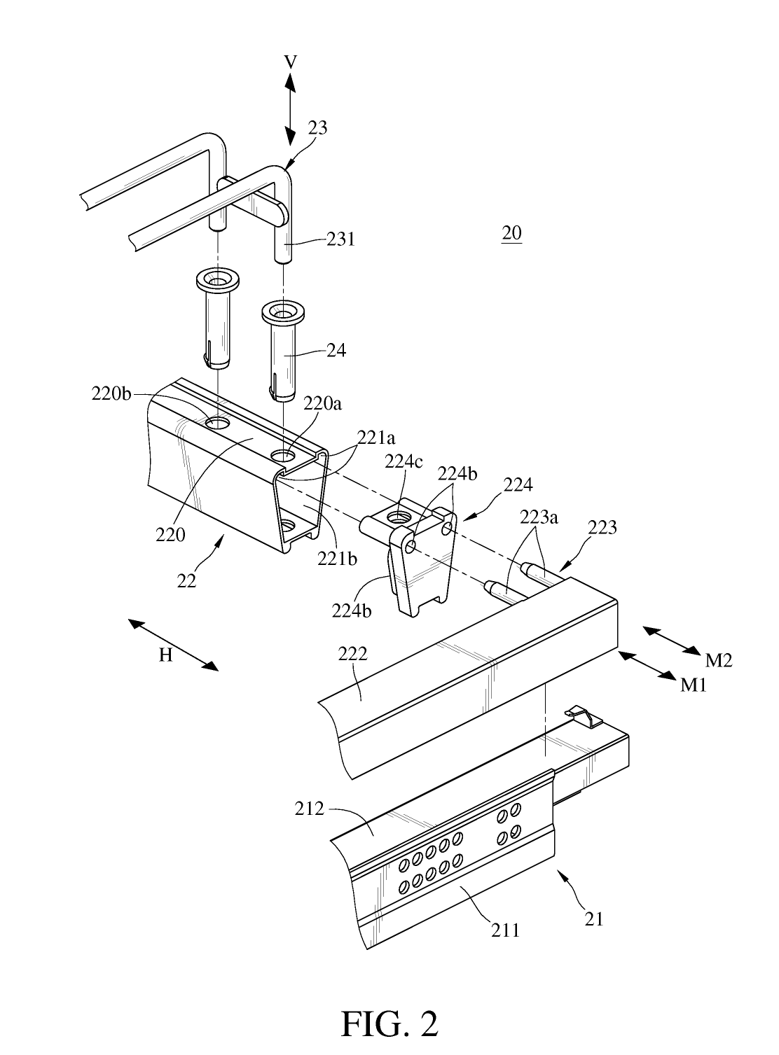

FIG. 2 is a partial exploded view of the carrying device according to another embodiment of the disclosure. As seen in FIG. 2, the carrying device 20 is similar to the carrying device 10 of FIG. 1B. The carrying device 20 comprises a pair of sliding rails 21, a support stand 22 and a plurality of rods 23. Each sliding rail 21 comprises a fixed rail 211 and a withdraw rail 212. Each withdraw rail 212 is capable of moving back and forth relative to each fixed rail 211. The support plate 22 has a top surface 220 and a plurality of sleeve holes 220a and 220b are disposed on the top surface 220. The sleeve holes 220a and 220b has a sleeved axis V. The opposite two ends of the support stand 22 each have two installation holes 221a. The two installation holes 221 a have two installation axes M1 and M2. The installation holes 221a are located on the two sides of the sleeved axis V while the sleeved axis V and the installation axes M1 and M2 do not intersect and thus do not interfere with each other. The withdraw rail 212 is installed on the installation hole 221a of the support stand. These fixed ends may be installed in the sleeve holes 220a and 220b of the support stand 22.

The ways of the opposite two sides of the support stand 22 being installed on each withdraw rail 212 are similar so only one side is shown in FIG. 2. The carrying device 20 further comprises a pair of sliding sleeve members 222, a pair of protruding portions 223, a pair of end covers 224 and a plurality of sleeves 24. Each fixed end 231 is installed on each sleeve hole 220a and 220b via each sleeve 24. Each protruding portion 223 is fixed to each sliding sleeve member 222. Each sliding sleeve member 222 is disposed on each withdraw rail 212. Each protruding portion 223 comprises two pluggable members 223a. Each end cover 224 comprises a pluggable protrusion 224a and has two through channels 224b. The two ends of the support stand 22 respective have a recessed portion 221b which connects the installation hole 221a. The sleeve hole 220a at the end of the support stand 22 connects the recessed portion 221b. The two pluggable members 223a of each protruding portion 223 are respectively plugged in the two through channels 224b of each end cover 224. Each pluggable protrusion 224a is plugged in each recessed portion 221b. The two pluggable members 223a of each protruding portion 223 are respectively plugged in each installation hole 221a via the two through channels 224b.

In this embodiment, however, the support stand 22 does not come with the fixing member. Instead, each pluggable protrusion 224a has a through hole 224c. In the multiple sleeves 24, the pair of sleeves 24 on the opposite ends of the support stand 22 pass through each sleeve hole 220a and each through hole 224c in order to fix the support stand 22 and the end cover 224 via the sleeve 24. In this embodiment, the shapes of the pluggable member 223a and the through channels 224b are cylindrical but they are not limited thereto. In other embodiments, the shapes thereof may be flat rectangular.

In this embodiment, the sliding rails 21 may be installed on two side walls (not shown in the figures). The friction between the two pluggable members 223a and the two through channels 224b can make each end cover 224 and each sliding sleeve member 222 to be along the horizontal direction H and with certain distances between them. When each end cover 224 is near each sliding sleeve member 222, the length of protruding portion 223 inside each installation hole 221b is longer. Thereby, the distance between the two sliding sleeve members 222 is reduced to match the two sliding rails 21 with shorter distance. When each end cover 224 is further away from each sliding sleeve member 222, the length of protruding portion 223 inside each installation hole 221b is shorter. Thus, the distance between the two sliding sleeve members 222 may be elongated to match the two sliding rails 21 with longer distance between them. In other words, each end cover may adjust the distance between the two sliding sleeve members 222 so that the carrying device 20 can be installed on two side walls with different distances.

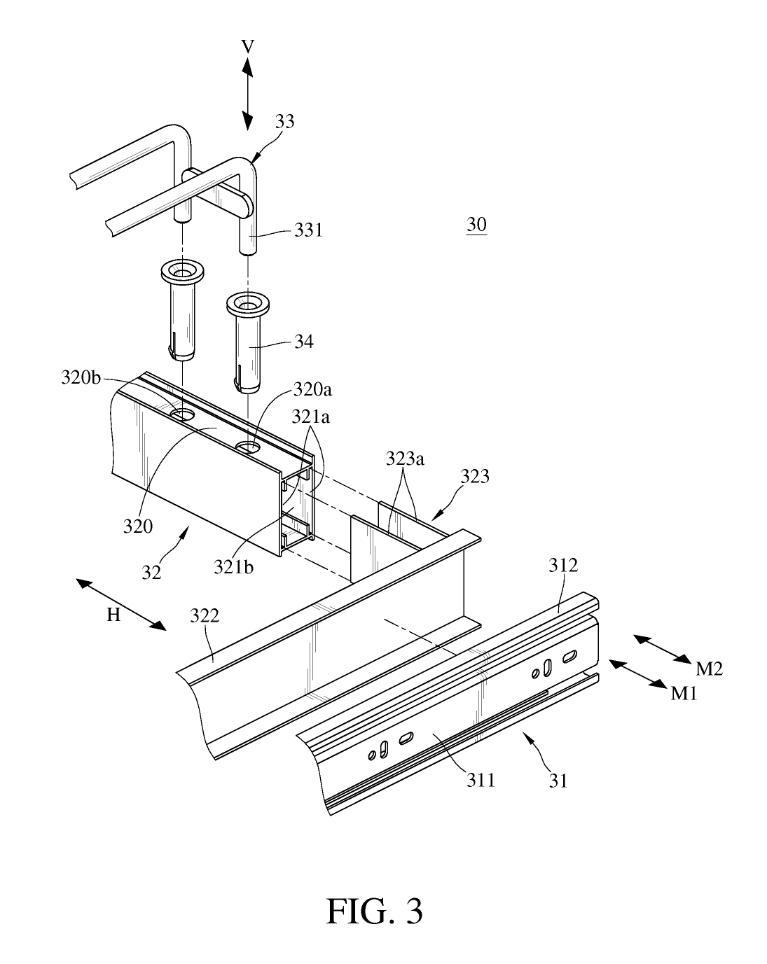

FIG. 3 is a partial exploded view of the carrying device according to another embodiment of the disclosure. As seen in FIG. 3, the carrying device 30 is similar to the carrying device 10 of FIG. 1B. The carrying device 30 comprises a pair of sliding rails 31, a support stand 32 and a plurality of rods 33. Each sliding rail 31 comprises a fixed rail 311 and a withdraw rail 312. Each withdraw rail 312 is capable of moving back and forth relative to each fixed rail 311. The support plate 32 has a top surface 320 and a plurality of sleeve holes 320a and 320b are disposed on the top surface 320. The sleeve holes 320a and 320b have a sleeved axis V. The opposite two ends of the support stand 32 each have two installation holes 321a. The two installation holes 321a have two installation axes M1 and M2. The installation holes 321a are located on the two sides of the sleeved axis V while the sleeved axis V and the installation axes M1 and M2 do not intersect and thus do not interfere with each other. The withdraw rail 312 is installed on the installation hole 321a of the support stand. These fixed ends may be installed in the sleeve holes 320a and 320b of the support stand 32.

The ways of the opposite two sides of the support stand 32 being installed on each withdraw rail 312 are similar so only one side is shown in FIG. 3. The carrying device 30 further comprises a pair of sliding sleeve members 322, a pair of protruding portions 323 and a plurality of sleeves 34. Each fixed end 331 is installed on each sleeve hole 320a and 320b via each sleeve 34. Each protruding portion 323 is fixed to each sliding sleeve member 322. Each sliding sleeve member 322 is disposed on each withdraw rail 312. Each protruding portion 323 comprises two pluggable members 323a. The two ends of the support stand 32 respective have a recessed portion 321b which connects the installation hole 321a. The sleeve hole 320a at the end of the support stand 32 connects the recessed portion 32 lb. The two pluggable members 323a of each protruding portion 323 are respectively plugged in each installation hole 321a.

In this embodiment, however, the support stand 32 does not come with the end cover and the fixing member. The shapes of pluggable member 323a and the installation hole 321a are flat rectangular but they are not limited thereto. In other embodiments, the shapes thereof may be cylinders or other shapes.

In this embodiment, the sliding rails 31 may be installed on two side walls (not shown in the figures). The friction between the two pluggable members 323a and the two through channels 324b can make each end cover 324 and each sliding sleeve member 322 to be along the horizontal direction H and with certain distances between them. When each end cover 324 is near each sliding sleeve member 322, the length of protruding portion 323 inside each installation hole 321b is longer. Thereby, the distance between the two sliding sleeve members 322 is reduced to match the two sliding rails 31 with shorter distance. When each end cover 324 is further away from each sliding sleeve member 322, the length of protruding portion 323 inside each installation hole 321b is shorter. Thus, the distance between the two sliding sleeve members 322 may be elongated to match the two sliding rails 31 with longer distance between them. In other words, each end cover may adjust the distance between the two sliding sleeve members 322 so that the carrying device 30 can be installed on two side walls with different distances. In other embodiments, when the length of the support stand 32 is greater than the minimum distance between the protruding portion 323 on one side and the sliding sleeve member 322 on the other side, the support stand may move along the horizontal direction H relative to the protruding portion 323.

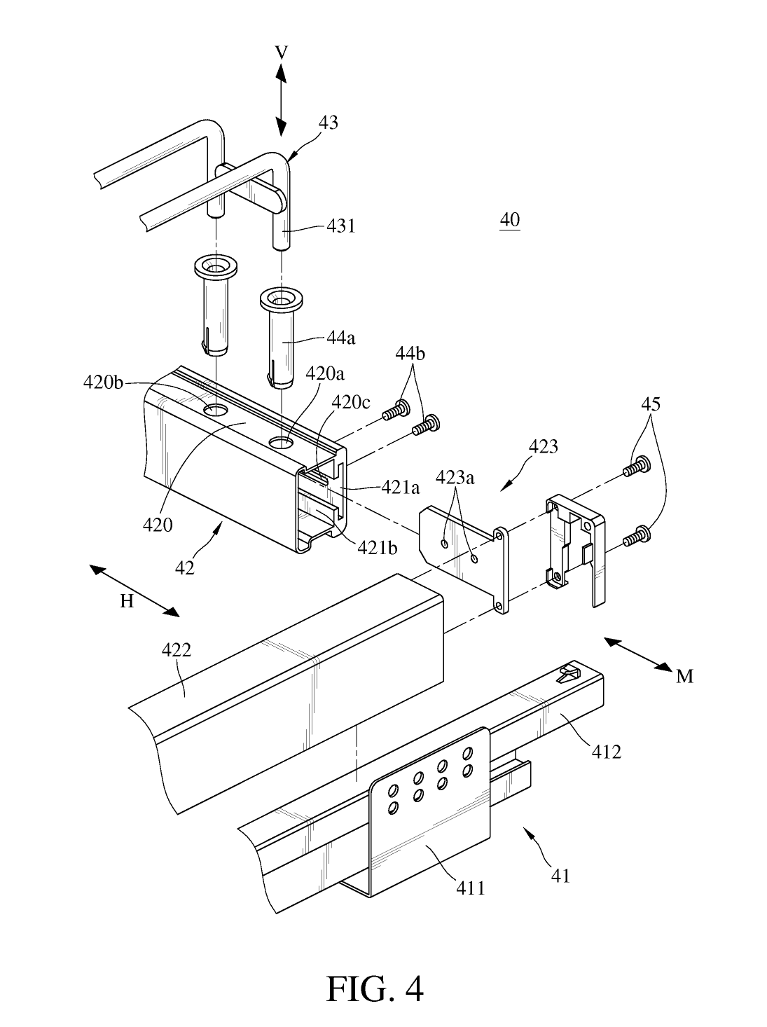

FIG. 4 is a partial exploded view of the carrying device according to another embodiment of the disclosure. As seen in FIG. 4, the carrying device 40 is similar to the carrying device 10 of FIG. 1B.

The carrying device 40 comprises a pair of sliding rails 41, a support stand 42 and a plurality of rods 43. Each sliding rail 41 comprises a fixed rail 411 and a withdraw rail 412.

Each withdraw rail 412 is capable of moving back and forth relative to each fixed rail 411. The support plate 42 has a top surface 420 and a plurality of sleeve holes 420a and 420b are disposed on the top surface 420. The sleeve holes 420a and 420b has a sleeved axis V. The opposite two ends of the support stand 42 each have two installation holes 421a. The two installation holes 421a have two installation axes M1 and M2. The installation holes 421a are located on the two sides of the sleeved axis V while the sleeved axis V and the installation axes M1 and M2 do not intersect and thus do not interfere with each other. The withdraw rail 412 is installed on the installation hole 421a of the support stand 42. These fixed ends may be installed in the sleeve holes 420a and 420b of the support stand 42.

The ways of the opposite two sides of the support stand 42 being installed on each withdraw rail 412 are similar so only one side is shown in FIG. 4. The carrying device 40 further comprises a pair of sliding sleeve members 422, a pair of protruding portions 423, and a plurality of first sleeves 44a. Each fixed end 431 is installed on each sleeve hole 420a and 420b via each first sleeve 44a. The two ends of the support stand 42 each have a installation hole 421a. Each protruding portion 423 may be locked into each sliding sleeve member 422 by the screw 45. Each sliding sleeve member 422 is disposed on each withdraw rail 412 and is located on the opposite ends of the support stand 42. Each protruding portion 423 is located in each installation hole 421a. The opposite two ends of the support stand 42 respectively has a recessed portion 421b which connects the installation hole 421a. The sleeve hole 420a at the end of the support stand 42 connects the recessed portion 421b.

In this embodiment, the support stand 42 does not dispose the end cover and the fixing member. The carrying device 40 further comprises two pairs of locking members 44b. These locking members 44b may be screws, for example. The opposite ends of the support stand 42 respectively have an opening 420c. Each opening 420c may be in a rectangular shape extending along the horizontal direction H. Each opening 420c connects each installation hole 421a. Each protruding portion 423 has a pair of through holes 423a. Each pair of locking members 44b pass through each opening 420c and each pair of through holes 423a to lock the protruding portion 423 into the support stand 42.

In this embodiment, the sliding rail 41 may be installed on the two side walls (not shown in the figures). Each protruding portion 423 is configured for moving along the shapes of each opening 420 and along the horizontal direction H. By locking the protruding portion 423 into the support stand 42 via the locking member 44b, the support stand 42 and each sliding member 44b may be arranged along the horizontal direction with certain distance between them. When the length of protruding portion 423 inside each installation hole 421 a is longer, the distance between the two sliding sleeve members 422 is reduced to match the two sliding rails 41 with shorter distance. When the length of protruding portion 423 inside each installation hole 421b is shorter, the distance between the two sliding sleeve members 422 may be elongated to match the two sliding rails 41 with longer distance between them. Thereby, the carrying device 40 can be installed on two side walls with different distances.

In the carrying device of the disclosure, the sleeved axis of the sleeve hole and the installation axis of the installation hole do not intersect and not interfere with each other so that the opposite ends of the support stand can disposed a pair of sliding rails and can dispose the sleeve hole for the rods to be installed on. Moreover, users can adjust the length of the protruding portion inside the installation hole to adjust the distance between the two sliding members. Thereby, the carrying device is capable of making the pairs of the sliding rails with different distances be installed on side walls with different distances.

What is claimed is:

1. A carrying device comprising:
a sliding rail comprising a fixed rail and a withdraw rail, wherein the withdraw rail is configured for moving back and forth relative to the fixed rail;
a support stand having a top surface, wherein a plurality of sleeve holes are disposed on the top surface, the sleeve holes have a sleeved axis, opposite two ends of the support stand respectively have at least one installation hole having an installation axis, the sleeved axis and the installation axis do not intersect, and the withdraw rail is installed on the installation hole of the support stand; and
a plurality of rods each having a fixed end and a cantilever end opposite to each other, wherein each of the fixed ends is installed on each of the sleeve holes of the support stand.

2. The carrying device according to claim 1, wherein the sliding rail has a withdraw direction, the withdraw rail is configured for moving away from the fixed rail along the withdraw direction, each of the fixed ends is installed on each of the sleeve holes by installing along each of the cantilever ends towards the withdraw direction.

3. The carrying device according to claim 1, further comprising a sliding sleeve member and a protruding portion, wherein the protruding portion is fixed to the sliding sleeve member, the sliding sleeve member is disposed on the withdraw rail, and the protruding portion is installed in the installation hole along the installation axis.

4. The carrying device according to claim 3, wherein the protruding portion comprises two pluggable members, the support stand further comprises an another installation hole, the another installation hole has an another installation axis which does not intersect with the sleeved axis, and the two pluggable members are plugged in the installation holes respectively.

5. The carrying device according to claim 4, wherein the installation holes are located on two sides of the sleeved axis.

6. The carrying device according to claim 4, further comprising a end cover, wherein the end cover comprises a pluggable protrusion and has two through channels, opposite two ends of the support stand respectively have a recessed portion, the pluggable protrusion is plugged in the recessed portion, and the two pluggable members are plugged in the two through channels respectively.

7. The carrying device according to claim 6, wherein the recessed portion connects the installation hole.

8. The carrying device according to claim 6, wherein the sleeve holes on the two ends of the support stand connect the recessed portion.

9. The carrying device according to claim 8, further comprising a sleeve, wherein the pluggable protrusion has a through hole, the sleeve penetrates the sleeve hole and the through hole which are on the two ends of the support stand.

10. The carrying device according to claim 6, further comprising a fixing member disposed between the end cover and the two through channels, wherein the fixing member is configured for moving between a first position and a second position, the fixing member at the first position fixes the protruding portion and the end cover, while the protruding portion and the end cover are able to move relative to each other when the fixing member is at the second position.
